(19) United States
(12) Patent Application Publication
(10) Pub. No.: US 2010/0292890 A1
(43) Pub. Date: Nov. 18, 2010

(54) Vehicle Rules Engine

(76) Inventor: William S. Morris, Portage, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/464,618

(22) Filed: May 12, 2009

(51) Int. Cl. G06F 7/00

(52) U.S. Cl. 701/33

(57) ABSTRACT

A system and method for generating custom rules to detect desired conditions of a vehicle and customize the information returned when the desired conditions are met. The system includes an authoring device having an authoring tool to author the custom vehicle retrieval rules. The authoring device communicates with the vehicle rules engine in the vehicle or optionally communicates with a client device that then communicates with the vehicle rules engine.

### FIELD OF THE INVENTION

The invention herein relates generally to the creation of rules generated to detecting conditions in vehicles and returning information specified by these rules. The information returned is in a specified form that will be understood and useful to the recipient.

### BACKGROUND OF THE INVENTION

Vehicle data is made available for use and recordation by interfacing with a vehicle's electronic control units (ECUs). Traditionally the information is extracted from a vehicle's ECUs by connecting a device, such as a scan tool or diagnostic tool, to a connector (such as OBDII) in the vehicle. The information extracted from the ECUs is dependent on the information available and the programming of the device used to get the information. The user of such a device is limited by what the device is designed to do and the information gathered by the rules set for said device. Once the information in extracted, it is generally usable only by those with the training and experience to know what the information represents. However, additional information that is not normally extracted by the scan tool are available for a user to extract as needed.

It is therefore desirable to provide a method and an apparatus for retrieving vehicle data based on customized rules for extracting certain types of information, and returning the information desired by the user and in the format desired by the user to suit his needs.

### SUMMARY OF THE INVENTION

The foregoing needs are met, to a great extent, by the present invention, wherein one embodiment provides a method and an apparatus allowing for the authoring and use of custom vehicle data retrieval rules.

In accordance with one embodiment of the present invention, a method of vehicle data retrieval is provided, which can include authoring custom vehicle data retrieval rules, loading the custom vehicle data retrieval rules to a vehicle rules engine, detecting a condition compliant with the conditions of the custom vehicle data retrieval rules, and returning information specified by the custom vehicle data retrieval rules.

In accordance with another embodiment of the present invention, an apparatus for vehicle data retrieval is provided which can include a client device, linked to a communication device, which is further linked to a vehicle rules engine, which in turn is linked to a plurality of electronic control units and stores vehicle module definitions.

In accordance with still another embodiment of the present invention, a system for vehicle data retrieval is provided which can include a means for authoring custom vehicle data retrieval rules, a means for communication, which allows for communication between the means for authoring and a means for processing and storing, where the means for processing and storing stores custom vehicle data retrieval rules and vehicle module definitions, reads data from electronic controllers, and returns specified information.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a schematic view of a custom vehicle data retrieval rules system according to an embodiment of the present invention;

FIG. 2 shows a schematic view of a custom vehicle data retrieval rules system according to another embodiment of the present invention; and

FIG. 3 shows a flow-chart view of a custom vehicle data retrieval rules method according to an embodiment of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

Electronic control units (ECUs) are capable of collecting abundant useful information related to the vehicle they are installed in. The information include data from sensors, distance travelled, time engine had been running, time between maintenance of the vehicle, miles since last oil change, the current location of the vehicle, and other useful information. Such information is often used to track, analyze, and diagnose vehicle conditions and can be used to indirectly gauge the conditions of an operator of the vehicle. This vehicle data is commonly used during vehicle service and maintenance. However, vehicle data retrieval and use are commonly limited to technicians with the training and experience to decipher the meaning of vehicle data readouts. What vehicle data is retrieved and how it is presented is limited by the tools available to extract vehicle data.

An embodiment in accordance with the present invention provides an apparatus and method for customizing vehicle data retrieval rules (customized rules). Such customization may allow one to define what vehicle data is extracted from the ECUs, what conditions need to be met to trigger a rule, what information is returned once when the rule is triggered, and to whom and when the information is delivered.

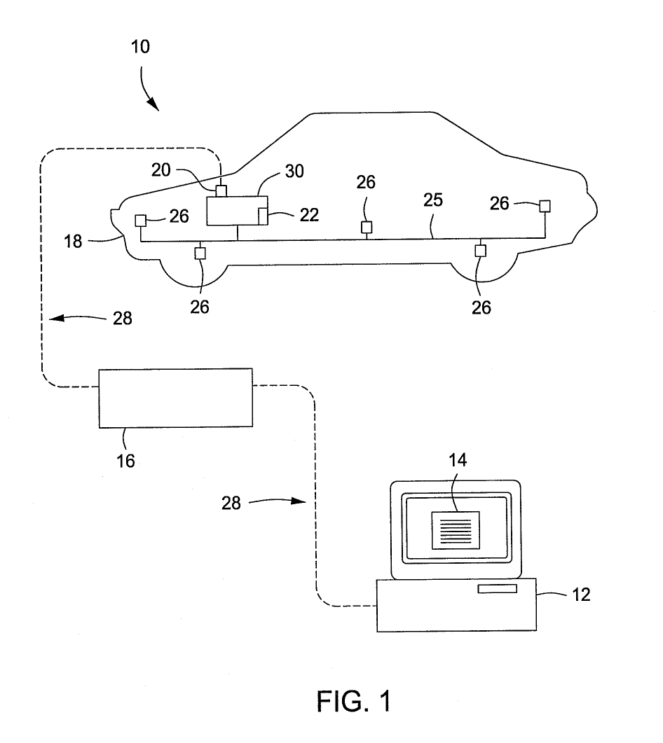

Referring now to FIG. 1, which illustrates a custom vehicle data retrieval rules system 10 according to an embodiment of the invention. The system 10 may include an author device 12, a client device 16, a vehicle 18 all of which can communicate with each other via a communications network 28.

In one embodiment, the author device 12 and the client device 16 may be a computing device, such as a personal computer (PC), a notebook, a UNIX workstation, a server, a mainframe computer, a personal digital assistant (PDA), a scan tool, a smartphone or other computing devices, capable of connecting to the communications network 28 and having the ability to run an authoring tool 14. Depending on which embodiment herein, the authoring tool 14 can be stored on the author device 12 and/or the client device 16.

The author device 12 and the authoring stored thereon or accessed via the communications network 28 to the client device 16, may be used by an author develop custom vehicle data retrieval rules. The custom rules written by an author will detect specified conditions and return the information designated and formatted by the custom rules, as discussed below. Custom rules created on the authoring device 12 may be transferred over the communications network 28 to the client device 16 for further execution with the vehicle. Over the same communications network 28, the authoring tool 12 may serve to receive information generated by the custom rules' execution from the client device 16.

In some embodiments, the authoring tool 14 may be a software allowing the author to construct custom rules either typographically and/or graphically, such as through a graphical user interface (GUI). Constructing the custom rules may be accomplished by using available or proprietary, programming, scripting, and domain specific languages. Such languages may include C, Python, and XML, as non-limiting group of examples.

As stated above, the ECUs of the vehicles contain various information such as distance travelled since the vehicle was in service, since it has left a certain location, how long the engine had been running, time since the maintenance of the vehicle, miles since last oil change, the current location of the vehicle, length of time between starting the vehicle and stopping for a certain period of time, and other information. This information is not typically retrieved by a scan tool, but can be useful for a fleet manager to ensure that a driver gets the required rest or that the vehicle is properly maintained at the correct intervals. Thus, with the authoring tool 12, the author can customized the rules in order to retrieve the data of interest from the ECUs.

The authoring tool 12 can also transmit these rules “on the fly” to the vehicle in order to retrieve the required information. The advantage of this is that it may be necessary to customize the rules for a particular vehicle or driver. For example, when a driver is only allowed to drive four hours instead of the usual eight hours, but took a vehicle that had rules to notify at an eight hour interval, the rules may be need to be customized “on the fly” for the vehicle to alert a fleet manager that the four hours will be reached soon, has been reached or has been passed. This “on the fly” feature allows the fleet manager to keep the vehicles and the drivers working while being able to adjust accordingly to the changing circumstances.

In any of the embodiments, the communications network 28 may link and transfer data between any combination of the authoring device 12, the client device 16, and the vehicle 18. The data transferred over the communications network 28 may include the custom rules and the return information from the execution of the custom rules or any communication needed between them. The communications network 28 may be, for example, the Internet; an intranet or extranet; a local area network (LAN) including a mesh network; a wide area network (WAN); a wireless wide area network (WWAN); a direct cable connection; a private network; a virtual private network (VPN); a public network; a dynamic domain name system; an Ethernet-based system; a token ring; a value-added network; a telephony-based system, including, for example, T1 or E1 devices; an Asynchronous Transfer Mode (ATM) network; a wired system; a wireless system; an optical system; a combination of any number of distributed processing networks or systems or the like or a combination of any of the foregoing. Communication could likewise be limited to a list of preapproved valid IP address.

One embodiment of the current invention provides that the client device 16 may be a server capable of connecting to the communication network 28, and providing storage, routing, and control functions for the information sent between the authoring device 12 and the vehicle 18. The client device 16 may be an intermediary device between the devices which create the custom rules, the devices that execute the custom rules, and the devices which receive the information returned from the execution of the custom rules. As an intermediary device, the client device 16 may provide storage for any of the data used or created by the system. Because the client device 16 is connected to the communications network, it is feasible that other device would have access to the stored data.

The client device 16 may also receive transmitted data from any number of devices and forward the information received to the proper device. For example, the author device 12 may transmit custom rules to the client device 16, and these custom rules may then be routed to a specific group of vehicles 18 within a large fleet of vehicles. This may also work in reverse when the executed custom rules return information, the client device 16 may receive the returned information and route the information to the author device 12 or any other proper receiving device, such as the computer of a vehicle fleet manager or maintenance chief or repair scheduler.

A control function may also be implemented by the client device 16. Such a function may serve to control the sending of data to and receiving data from the vehicles 18. The client device 16 may limit when data is sent to and retrieved from the vehicles 18 to specific times and/or intervals or locations. If there are a number of devices communicating with the vehicles 18, this implementation of client device 16 may reduce the load on the vehicles 18 by limiting frequent data transmission to and from multiple sources, to a restricted number of transmissions to and from the multiple sources.

An embodiment of the vehicle 18 may include a communication device 20, a vehicle rules engine 22 (VRE), vehicle module definitions (VMD) (not shown), a data bus 25 linking ECUs 26, and a vehicle communication interface 30 (VCI). The vehicle 18 may be any vehicle that could incorporate the use of these components to gather data from the vehicle's systems. Examples of such vehicles 18 may include a car, truck, motorcycle, airplane, helicopter, or boat.

The vehicle 18 may include the VCI 30 having an OBD II connector or similar communication interface. The VCI 30 linked to the data bus 25, which links the ECUs 26 to each other and the VCI. Connecting to the VCI 30 allows for communication between the authoring tool and/or the client device with the ECUs 26 in vehicle 18. The VCI 30 may further contain memory and a processor to increase functionality.

Connected to the VCI 30 may be a communication device 20 capable of connecting to the communication network 28. The communication device 20 allows for the receipt and transmittance of data between the vehicle 18 and other devices, such as the authoring device 12 and/or the client device 16, over the communication network 28. The communication device may integral with the VCI 30 or located externally thereto.

The VCI 30 may store in its memory the VMDs, which define what information will be made available from each of the ECUs 26. These VMDs may be preloaded into the VCI 30. The VMDs may also be transferred to the VCI 30 by the authoring device 12 and/or the client device 16 over the communication network 28 and then loaded into the VCI 30. Similarly, the VMDs may be updated over the communication network 28.

Included in the embodiments of the invention is the VRE 22, which may be located in the vehicle 18. The VRE 22 may be software contained in the memory of the VCI 30. The VRE 22 could receive and run the custom rules, access the VMDs to monitor the information made available from the ECUs 26, collect and/or generate, and return the information designated by the custom rules. The VRE 22 may be updated with new or edited custom rules or “on the fly” over the communications network 28 much like the VMDs. There also may be a generic rules engine with rules to monitor basic data, such as engine RPMs, temperature, and speed as part of the VRE 22, preloaded to the VCI 30. The VCI 30 allows for communication between the VRE 22 and the ECUs 26.

In another embodiment, the VRE 22 may be the software of the previous embodiment combined with dedicated hardware (not shown) having memory and a processor, and may store and receive updates for the VMDs and VRE 22, including custom rules. The VRE 22 could be linked to the VCI 30 to allow for communication with the ECUs 26. Further, the VRE 22 may be connected to the communication device 20 to allow for data transmission over the communication network 28.

A further consideration for the embodiments of this invention is that the authoring tool 14 could compile the custom rules to a format the VRE 22 can interpret and this allows greater flexibility because updates to the custom rules could be implemented on the authoring side without have to update the VRE's 22 firmware.

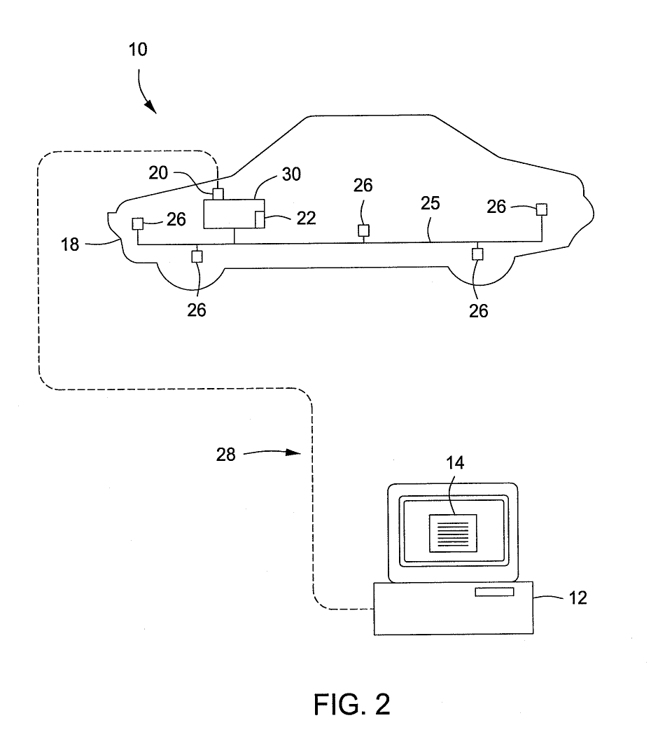

Referring now to FIG. 2, which illustrates another embodiment of the custom rules system 10. In this embodiment, the client device 16 may have the ability to run the authoring tool 14, replacing and incorporating the capabilities of the author device 12 of the previous embodiments.

In still another embodiment, the authoring device 12 may operate without the assistance of the client device 16. In this embodiment, the authoring device 12 would now communicate directly with the vehicle 18 via communications network 28.

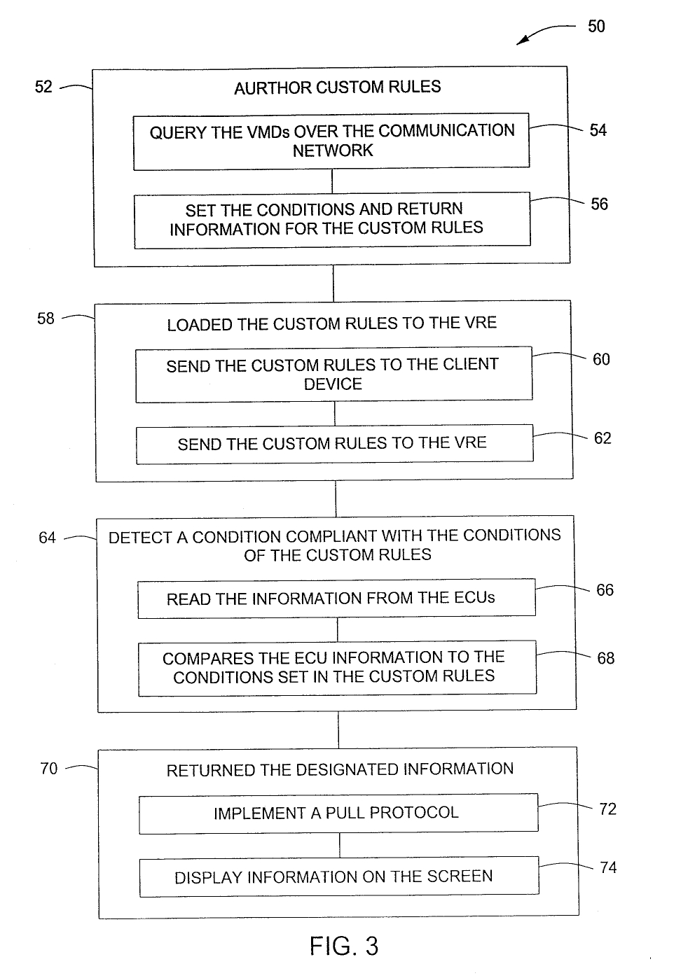

Referring now to FIG. 3, a custom vehicle data rules method 50 allows a user to author custom rules 52, load the custom rules to the VRE 58, detect a condition compliant with the conditions of the custom rules 64, and returned the designated information 70.

To author custom rules (step 52), the user may use the authoring tool 14 to first query the VMDs over the communication network (step 54), to figure out what information will be available from the vehicle 18 for which the user is authoring custom rules. Knowing what information is available for retrieval, the author may then author rules to set the conditions and return information for the custom rules to which triggers a return of the information (step 56). An example of a rule may be when a vehicle runtime >10 hours, then trigger RSS named “Worked too long.” Another example could be when brake duty cycle >75% within 15 minutes then trigger RSS names “Driver burning up brakes.” The authoring tool can also query the current vehicle retrieval rules in case they are not known.

It may not be necessary to query the VMDs or skip step 52. It is possible that the information from the VMDs is already available to the author, for example, from a prior query where the results were stored, or from previous knowledge.

Once created using the authoring tool 14, the custom rules are then loaded onto the VRE (step 58). The custom rules are sent to the client device (step 60) via the communication network 28, if the client device is utilized. The client device in turn sends the custom rules to the VRE (step 62) through the communication network 28. Step 62 of sending the custom rules to the VRE may be controlled by a set of rules that control when and to which VRE a data transmission is sent.

Another embodiment allows the user to run the authoring tool 14 on the client device 16, and author custom rules on the client device 16. In this embodiment, the custom rules are then sent directly from the client device to the VRE (step 62) over the communication network 28, and there is no need to send the custom rules to the client device 60.

Security concerns in sending the custom rules from any device described herein to the VRE can be addressed by encrypting the rules prior to sending them. Any encryption protocol may be utilized to overcome these concerns.

After receiving the custom rules, the VRE detects a condition compliant with the conditions of the custom rules (step 64). In doing so, the VRE reads the information from the ECUs (step 66), and compares the ECU information to the conditions set in the custom rules (step 68). The detecting step 64 may be run as a edge triggered function (one time) or may be run continuously. Once the information from the ECUs matches the conditions of a custom rule(s), the VRE collects and/or generates the return information defined by the custom rule. Such information may include actual vehicle data and/or predefined custom messages. The return information may be contained in a data file.

Once collected and/or generated, the information will now be returned (step 70) over communication network 28 to a client device 16, which may be the information's terminus point, or the information may be forwarded to another device, including the author device 12. Step 70 may be returned once the conditions were met or can be held so that they are delivered at the appropriate time or interval. The information might also transmit directly to the author device 12 in another embodiment. Sending the information from the VRE to another device may be accomplished by implementing a push protocol, such as e-mail, instant messaging, fax or any other data transmittable format. A system using a push protocol would require that the VRE has prior contact information of the recipients.

In another embodiment of the invention, returning the information (step 70) is accomplished by implementing a pull protocol (step 72), such as Real Simple Syndication (RSS). In such a situation, the protocol may be implemented by a device that is not aware whether a custom rule has been triggered or not. The device would request return information regardless if any happened to be available. A pull protocol allows retrieval of information without prior knowledge of the recipients.

Any available or proprietary software capable of receiving the data files from the VRE may be used to implement retrieval of the information sought by the custom rules. For example, one might use Microsoft Outlook to receive e-mail notifications from the VRE or an RSS aggregator to receive RSS feeds such as the ones built into Microsoft Internet Explorer or Mozilla Firefox.

The information retrieved from the vehicle may be displayed on a display (step 74) remote from the vehicle, such as in a fleet manager's office. Another embodiment of the current invention may include the vehicle 18, where the VRE is installed, having a screen. The rules, when triggered, may have a feature to display information on the screen (step 74). Such information may inform the vehicle operator of conditions in the vehicle 18 or related to the operation of the vehicle 18.

The information returned from the VRE can be customized such that the intended recipient should be able to easily understand what information they are receiving and how to use it. For example, raw technical data can be sent to technicians. Also, custom messages triggered by a specific condition can be sent to notify a person monitoring the system of an issue requiring attention, for example, the driver has been driving for too many hours or the brakes need maintenance. With this type of information, the recipient can take immediate action or schedule the proper action to be taken.

In another embodiment, the driver of the vehicle can receive this information on a built in vehicle display. These custom rules can be used to detect if the driver is driving is abnormally, such as increasing and decreasing speed in a short amount of time indicating health issues or he is falling asleep. A signal can be send to the vehicle display to flash or to beep or otherwise notify the driver or wake him up. The message can include “pull over” or “stop and rest” or any message desired by the author.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of vehicle data retrieval, comprising the steps of:
authoring a custom vehicle data retrieval rules with an authoring tool based on current vehicle module definitions stored in a vehicle;
loading the custom vehicle data retrieval rules into a vehicle rules engine stored in the vehicle;
detecting a condition compliant with a rule of the custom vehicle data retrieval rules; and
returning information specified by the custom vehicle data retrieval rules.

2. The method of claim 1, wherein authoring custom vehicle data retrieval rules further comprises the steps of:
setting conditions based on data from available vehicle module definitions stored in the vehicle; and
setting the information to be returned when the conditions are met.

3. The method of claim 1, wherein loading the custom vehicle data retrieval rules further comprises the steps of:
sending the custom vehicle data retrieval rules from an author device having the authoring tool to a communication unit in the vehicle; and
transferring the custom vehicle data retrieval rules from the communication unit to the vehicle rules engine.

4. The method of claim 1, wherein detecting a condition further comprises the steps of:
reading data available to the vehicle rules engine from available data sources as defined by the vehicle module definitions installed on the vehicle rules engine; and
comparing the data to the conditions of the custom vehicle data retrieval rules.

5. The method of claim 1, wherein returning information further comprises the steps of:
implementing a pull protocol; and
responding to a request for information sent from a client device.

6. The method of claim 5, wherein the pull protocol is implemented using Real Simple Syndication (RSS) feeds.

7. The method of claim 5, wherein authoring custom vehicle data retrieval rules further comprises the step of:
querying the vehicle rules engine for the vehicle module definitions.

8. The method of claim 1 further comprising displaying the returning information on a display.

9. The method of claim 1, wherein returning information further comprises the steps of:
implementing a push protocol.

10. The method of claim 9, wherein the push protocol pushes an e-mail or a fax.

11. The method of claim 9, wherein the push protocol pushes instant messaging.

12. The method of claim 9, wherein authoring custom vehicle data retrieval rules further comprises the step of:
querying the vehicle rules engine for the vehicle module definitions.

13. The method of claim 1, wherein authoring custom vehicle data retrieval rules further comprises the step of:
querying the vehicle rules engine for existing vehicle retrieval rules.

14. An apparatus for authoring custom vehicle data retrieval, comprising:
an author device configured to communicate with a vehicle rules engine in a vehicle, to request information from the vehicle rules engine, and transmit the information to a first user device communicatively linked to the author device;
an authoring tool stored on the author device and configured to author custom vehicle data retrieval rules; and
a communication network configured to provide communication between the author device and the vehicle rules engine.

15. The apparatus of claim 14, wherein the custom vehicle data retrieval rules set a condition in the vehicle that must be met before data associated with the condition are communicated back to the author device.

16. The apparatus of claim 15, wherein the communication network is a wireless network.

17. The apparatus of claim 16, wherein the communication network is a wired network.

18. The apparatus of claim 14, wherein the vehicle rules engine further includes a vehicle module definitions.

19. The apparatus of claim 14, further comprising a client device configured to receive the custom vehicle data retrieval rules from an authoring device and send the custom vehicle data retrieval rules to the vehicle rules engine.

20. The apparatus of claim 14, wherein the communication network utilizes a push protocol.

21. The apparatus of claim 20, wherein the push protocol pushes email or a fax to the first user device.

22. The apparatus of claim 14, wherein the communication network utilizes a pull protocol.

23. The apparatus of claim 22, wherein the pull protocol pulls real simple syndication (rss) feeds to the first user device.

24. The apparatus of claim 23, wherein the rss feeds contains information about a condition of the vehicle.

25. The apparatus of claim 14, wherein the request information from the vehicle rules engine include information about the current vehicle retrieval rules in the vehicle.

26. The apparatus of claim 14, wherein the request information from the vehicle rules engine include information about vehicle module definitions.

27. A system for vehicle data retrieval, comprising:
a means for processing configured to communicate with a vehicle rules engine in a vehicle, to request information from the vehicle rules engine, and transmit the information to a first user device communicatively linked to the means for processing;
a means for authoring configured to author the custom vehicle data retrieval rules and stored on the means for processing; and
a means for communicating configured to provide communication between the means for processing and the vehicle rules engine.
